(19) United States
(12) Patent Application Publication
(10) Pub. No.: US 2024/0400392 A1
(43) Pub. Date: Dec. 5, 2024

(54) PROCESS

(71) Applicant: Q-FLO LIMITED, Sevenoaks (GB)

(72) Inventors: Bruce Richard WILLIAMS, Sevenoaks (GB); Jerónimo TERRONES, Sevenoaks (GB); Felix FREEBAIRN, Sevenoaks (GB); Martin PICK, Sevenoaks (GB); Adam BOIES, Sevenoaks (GB)

(73) Assignee: Q-FLO LIMITED, Sevenoaks (GB)

(21) Appl. No.: 18/697,723

(22) PCT Filed: Nov. 29, 2022
(86) PCT No.: PCT/GB2022/053015

§ 371 Date: Apr. 1, 2024

(30) Foreign Application Priority Data
Nov. 29, 2021 (GB) 2117202.8

(51) Int. Cl. C01B 32/164; B01J 8/00; C01B 32/162

(52) U.S. Cl. CPC C01B 32/164; B01J 8/008; C01B 32/162; B01J 2208/00893

(57) ABSTRACT

A process for the production of a carbon nanotube product comprises: introducing sequentially or concurrently a metal catalyst precursor, a source of carbon and a sulphur-containing additive into a continuous flow of a hydrogen-containing carrier gas in a temperature-controlled flow-through reactor; exposing the metal catalyst precursor in the flow of the carrier gas to a first temperature zone sufficient to generate particulate metal catalyst; exposing the catalyst, the source of carbon and the sulphur-containing additive to a second temperature zone downstream from the first temperature zone that can produce a carbon nanotube aggregate; discharging the aggregate as a continuous discharge through a discharge outlet of the reactor; collecting the continuous discharge in the form of a carbon nanotube product; and recycling continuously an exhaust stream of hydrogen by-product exhausted from the outlet to progressively replace the continuous flow. A temperature-controlled flow-through reactor for the production of a carbon nanotube product is also described.

The present invention relates to a process for the production of a carbon nanotube product and to a temperature-controlled flow-through reactor.

There is an increasing demand for lightweight products with high strength and stiffness, especially when combined with high electrical and thermal conductivity. Floating catalyst chemical vapor deposition (FCCVD) is a process which has been studied widely and used to manufacture CNT products (eg fibres) by aggregating CNTs to form a continuous network of entangled (or otherwise interlinked) CNTs such as an aerogel. Typically the FCCVD process carried out in a temperature-controlled flow-through reactor (eg furnace) involves a CNT growth reaction catalysed by nanoparticulate iron produced in situ in a hydrocarbon rich atmosphere enhanced by the presence of sulphur. Research has been directed towards different reaction mixtures and conditions to alter and improve the quantity and quality of the CNT product. However the cost-effective, continuous production of aligned macroscale CNT products for engineering applications by FCCVD remains a challenge.

The present invention relates to a process by which CNT products (eg fibres, films or sheets) may be manufactured continuously with advantageous utilisation of hydrogen which is a by-product of the hydrocarbon reaction and to a temperature-controlled flow-through reactor for achieving this.

Thus viewed from a first aspect the present invention provides a process for the production of a carbon nanotube product comprising:
(a) introducing sequentially or concurrently a metal catalyst precursor, a source of carbon and a sulphur-containing additive into a continuous flow of a hydrogen-containing carrier gas in a temperature-controlled flow-through reactor;
(b) exposing the metal catalyst precursor in the flow of the hydrogen-containing carrier gas to a first temperature zone sufficient to generate particulate metal catalyst;
(c) exposing the particulate metal catalyst, the source of carbon and the sulphur-containing additive to a second temperature zone downstream from the first temperature zone, wherein the second temperature zone is sufficient to produce a carbon nanotube aggregate;
(d) discharging the carbon nanotube aggregate as a continuous discharge through a discharge outlet of the temperature-controlled flow-through reactor;
(e) collecting the continuous discharge in the form of a carbon nanotube product; and
(f) recycling continuously an exhaust stream of hydrogen by-product exhausted from the discharge outlet into step (a) to progressively replace the continuous flow of the hydrogen-containing carrier gas.

The process achieves surprisingly high levels of effective recycling with the need only to replenish supplies of the metal catalyst precursor, the source of carbon or the sulphur-containing additive. This offers a significant reduction in raw material costs and reduced energy usage via hot gas recycling.

The exhaust stream of hydrogen by-product may be subjected to purification or filtration.

Preferably the temperature-controlled flow-through reactor comprises:
an elongate refractory housing (eg a furnace) extending from an upstream end to a downstream end;
a thermal enclosure surrounding the elongate refractory housing which is adapted to provide an axial temperature variation between temperature zones in the elongate refractory housing, wherein the temperature zones include the first temperature zone and the second temperature zone.

In step (a), the metal catalyst precursor may be introduced axially or radially into the temperature-controlled flow-through reactor. The metal catalyst precursor may be introduced through a probe or injector. The metal catalyst precursor may be introduced at a plurality of locations.

The metal catalyst precursor may be a suspension of solid particles (preferably solid nanoparticles).

The metal catalyst precursor may be a metal compound of at least one of the group consisting of Fe, Ru, Co, W, Cr, Mo, Rh, Ir, Os, Ni, Pd, Pt, Ru, Y, La, Ce, Mn, Pr, Nd, Tb, Dy, Ho, Er, Lu, Hf, Li and Gd.

Typically the metal catalyst precursor is a metal compound of iron.

The metal catalyst precursor may be a metal complex or organometallic metal compound.

Preferably the metal catalyst precursor is ferrocene.

Typically the particulate metal catalyst is a nanoparticulate metal catalyst. Preferably the nanoparticles of the nanoparticulate metal catalyst have a mean diameter (eg a number, volume or surface mean diameter) in the range 1 to 50 nm (preferably 1 to 10 nm). Preferably 80% or more of the particles of the nanoparticulate metal catalyst have a diameter of less than 30 nm. Particularly preferably 80% or more of the particles of the nanoparticulate metal catalyst have a diameter of less than 12 nm. The concentration of the particulate metal catalyst may be in the range 10⁶ to 10¹⁰ particles cm⁻³.

The sulphur-containing additive may be elemental sulphur, thiophene, iron sulphide, a sulphur-containing ferrocenyl derivative (eg ferrocenyl sulphide), hydrogen sulphide or carbon disulphide.

Preferably the sulphur-containing additive is thiophene.

In step (a), the source of carbon may be released axially or radially into the temperature-controlled flow-through reactor. The source of carbon may be introduced through a probe or injector. The source of carbon may be introduced at a plurality of locations.

Typically the source of carbon is a hydrocarbon.

The source of carbon may be an optionally substituted and/or optionally hydroxylated aromatic or aliphatic, acyclic or cyclic hydrocarbon (eg alkyne, alkane or alkene) which is optionally interrupted by one or more heteroatoms (eg oxygen). Preferred is an optionally halogenated C₁₋₆-hydrocarbon (eg methane, propane, ethylene, acetylene or tetrachloroethylene), an optionally mono-, di- or tri-substituted benzene derivative (eg toluene), C₁₋₆-alcohol (eg ethanol or butanol) or an aromatic hydrocarbon (eg benzene or toluene).

Typically the source of carbon consists essentially of (preferably consists of) methane gas.

Preferably the source of carbon is bio-produced methane, natural gas, industrial waste methane (eg with high levels of H₂S) or biogas-derived methane (eg with high levels of CO and/or CO₂) optionally diluted with hydrogen (eg 50% hydrogen).

The generation of particulate metal catalyst may be initiated in step (b) by thermal decomposition or dissociation of the metal catalyst precursor into metal species (eg atoms, radicals or ions). The generation of particulate metal catalyst in step (b) may comprise nucleation of the metal species into nucleated metal species (eg clusters). The generation of particulate metal catalyst may comprise growth of the nucleated metal species into the particulate metal catalyst.

The first and second temperature zones may extend over the range 600 to 1300° C. (or higher).

The hydrogen-containing carrier gas typically consists essentially of (preferably consists of) hydrogen gas. The flow rate of the hydrogen-containing carrier gas may be in the range 1000 to 50000 sccm (eg 30000 sccm).

The carbon aggregate may comprise multi-walled carbon nanotubes (eg double-walled carbon nanotubes) and/or single-walled carbon nanotubes.

The carbon aggregate may take the form of a 3D continuous network (eg an aerogel).

Preferably the carbon aggregate is an aerogel.

The carbon nanotube product may have substantially aligned carbon nanotubes.

The carbon nanotube product may be a powder, fibre, wire, film, ribbon, strand, sheet, plate, mesh or mat.

Viewed from a further aspect the present invention provides a temperature-controlled flow-through reactor for the production of a carbon nanotube product comprising:
an elongate refractory housing extending from an upstream end to a downstream end;
a feed system for releasing sequentially or concurrently a metal catalyst precursor, a source of carbon and a sulphur-containing additive into a continuous flow of a hydrogen-containing carrier gas;
an inlet at or near to the upstream end of the elongate refractory housing for introducing the continuous flow of the hydrogen-containing carrier gas which flows from the upstream end to the downstream end;
a thermal enclosure surrounding the elongate refractory housing which is adapted to provide an axial temperature variation between temperature zones in the elongate refractory housing, wherein the temperature zones include a first temperature zone sufficient to generate particulate metal catalyst and a second temperature zone sufficient to produce a carbon nanotube aggregate;
a collector for collecting from the downstream end a continuous discharge of the carbon nanotube aggregate in the form of a carbon nanotube product; and
a recycling system of pipework for continuously feeding into the feed system an exhaust stream of hydrogen by-product exhausted from the downstream end which progressively replaces the continuous flow of the hydrogen-containing carrier gas.

In a preferred embodiment, the recycling system of pipework comprises a primary pipeline between the downstream end and the feed system which incorporates a recycling pump. Particularly preferably the primary pipeline incorporates a flowmeter (eg a variable-area flowmeter such as a rotameter) or a control valve upstream from the recycling pump. More preferably the primary pipeline incorporates a filter (eg upstream from the flowmeter).

Preferably the recycling system of pipework comprises a secondary pipeline branched from the primary pipeline (eg at a position upstream from the pump), wherein the secondary pipeline incorporates ancillary equipment. Particularly preferably the secondary pipeline incorporates a flowmeter (eg a variable-area flowmeter such as a rotameter) or a control valve which proportions the flow of the exhaust stream of hydrogen by-product between the ancillary equipment and the feed system.

The ancillary equipment may be one or more of a gas purification column, a separator, a spectrometer (eg an infra-red spectrometer), a storage tank, a compressor or a vent.

A purification column or separator may be used to separate pure hydrogen (which can then be stored, sold and/or used in many other processes) from other gases (eg methane, heavier hydrocarbons from partial decomposition of methane or H₂S). This concentrated stock of process gases can potentially be re-used in the process according to the invention.

The feed system may comprise an injection nozzle, lance, probe or a multi-orificial injector (eg a shower head injector).

In a preferred embodiment, the feed system comprises a controller for controlling the release (eg the timing and metering) of the metal catalyst precursor, the source of carbon and the sulphur-containing additive into the continuous flow of the hydrogen-containing carrier gas.

Preferably the controller further controls the feeding (eg the timing and metering) of the exhaust stream of hydrogen by-product into the feed system to progressively replace the continuous flow of the hydrogen-containing carrier gas.

The elongate refractory housing may be substantially cylindrical (eg tubular).

The elongate refractory housing may be a furnace.

Typically the thermal enclosure is electrically-insulating.

The axial temperature variation may be non-uniform (eg stepped). The temperature of the temperature-controlled flow-through reactor may be controlled by resistive heating, plasma or laser.

The temperature-controlled flow-through reactor may be substantially vertical or horizontal.

The collector is typically electrically-conductive (eg metallic). The collector may be a rotary spindle, reel, winder or drum.

Viewed from a yet further aspect the present invention provides a method for the production of a carbon nanotube product comprising:
(1) introducing sequentially or concurrently a particulate metal catalyst, a source of carbon and a sulphur-containing additive into a continuous flow of a hydrogen-containing carrier gas in a temperature-controlled flow-through reactor;
(2) exposing the particulate metal catalyst, the source of carbon and the sulphur-containing additive to a temperature zone sufficient to produce a carbon nanotube aggregate;
(3) discharging the carbon nanotube aggregate as a continuous discharge through a discharge outlet of the temperature-controlled flow-through reactor;
(4) collecting the continuous discharge in the form of a carbon nanotube product; and
(5) recycling continuously an exhaust stream of hydrogen by-product exhausted from the discharge outlet into step (a) to progressively replace the continuous flow of the hydrogen-containing carrier gas.

The particulate metal catalyst may be prepared by from elemental metal (or a metal alloy) by (for example) ablation (eg laser, plasma or electric arc ablation).

The present invention will now be described in a non-limitative sense with reference to the accompanying Figures in which:

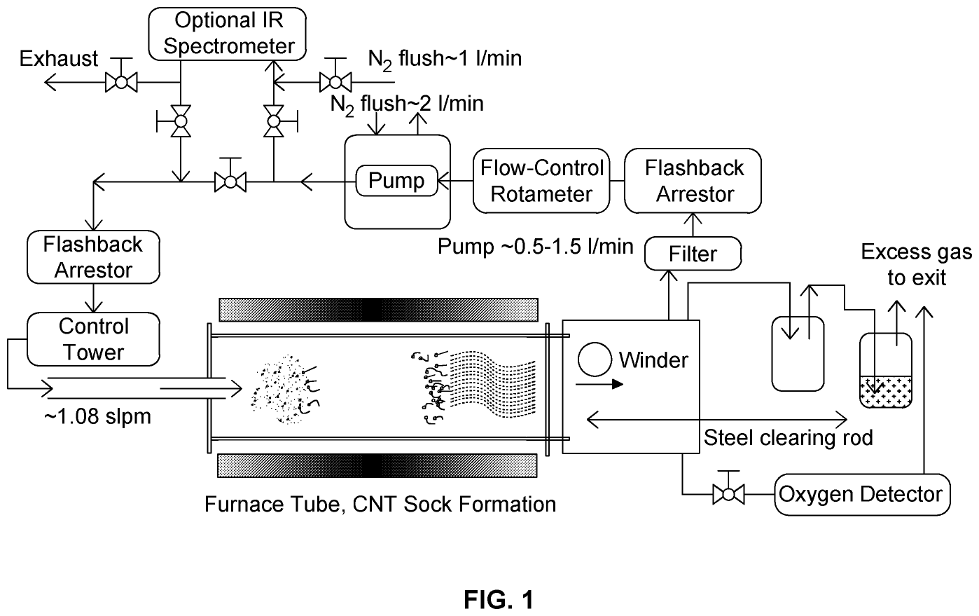

FIG. 1 shows in overview a temperature-controlled flow-through reactor fitted with a recycle gas line and water trap according to an embodiment of the temperature-controlled flow-through reactor of the invention; and

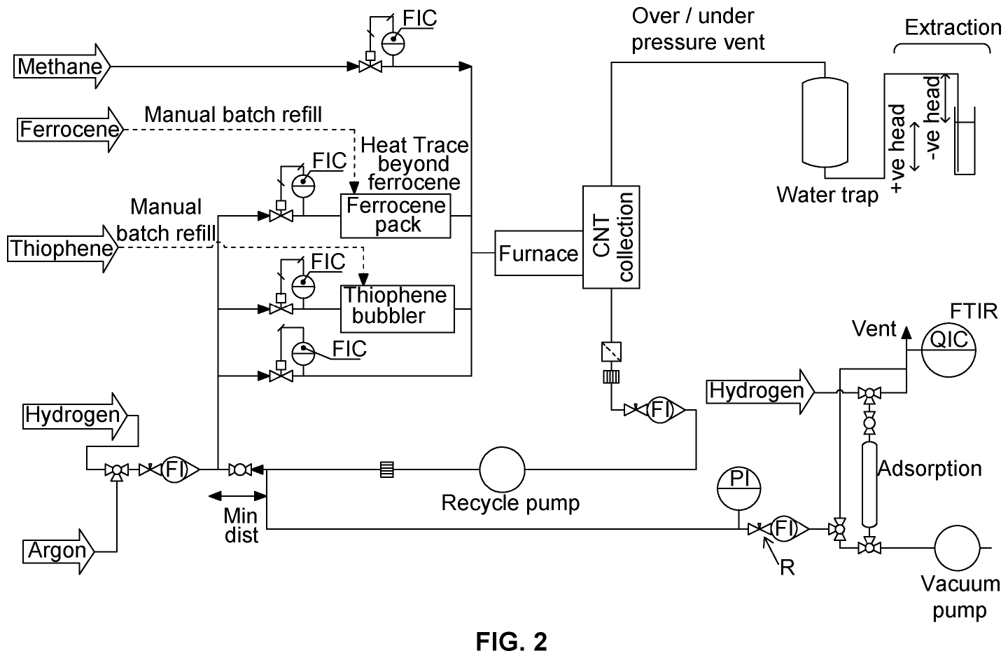

FIG. 2 shows a schematic piping and instrumentation diagram (P&ID) of a further embodiment of the temperature-controlled flow-through reactor of the invention.

A research-based temperature-controlled flow-through reactor shown in overview in FIG. 1 was constructed in order to produce continuously a CNT product on a winder and to exhaust an exhaust stream of surplus hydrogen gas that could be collected and purified for use as process gas. This involved connecting a pump to a branch in the exhaust line in order to extract and feed hydrogen to gas purification columns and an infra-red spectrometer. The branch and pump also enabled a gas line to be fed back to the injector and into the reactor to explore gas recycling.

Following experimentation and piping modification, the system was revised to include re-metering of the recycled gas at the setup's control panel rather than downstream which enabled the recycled gas to carry the reagents (thiophene and ferrocene) in place of fresh hydrogen from a bottled supply. It was anticipated that low levels of recycling would be possible. A secondary branch line to the gas purification columns and spectrometer was retained and was also used to relive line pressure in the event of build-up (due to gas production or fresh input of methane for example).

It was thought that a minimum amount of fresh hydrogen would be required to run the system continuously due to the necessity of suppling non-recyclable reagents and also due to the possibility of a build-up of impurities. However it was a surprise to find that the system worked with 100% recycled and re-metered exhaust gas (with fresh methane at reduced quantities being the only new input). Moreover the process was stable and wound fibre continuously for up to an hour with only minimal manual intervention and appeared to be limited only by the build-up of CNT product on the winding spool.

This research represents a novel process for optimising CNT production whilst using hydrogen exhaust gas in place of a fresh supply of hydrogen gas and with only methane and small quantities of thiophene and ferrocene as fresh inputs.

### Equipment and Process Overview

FIG. 1 indicates schematically the growth of a CNT aerogel in the form of a sock and where exhaust gases are directed. A control tower meters hydrogen gas and methane gas from bottles through mass flow controllers and directs a proportion of the gas flow through a heated ferrocene pack and a chilled thiophene bubbler to carry small quantities of ferrocene vapour and thiophene vapour respectively into the furnace. CNT formation occurs in the furnace and the exit of the furnace tube is connected directly to a small collection box containing a motorised winder which collects the solid CNT product. Exhaust gases are normally passed through a water trap which keeps the system at close to atmospheric pressure. When a recycling loop is engaged, the pump is turned on and the flow-control rotameter is opened enough to draw sufficient gas such that substantially no exhaust gas exits through the water trap. The pumped exhaust gas is optionally diverted to an infra-red spectrometer for analysis and/or gas columns for purification. Remaining gas is fed back to the control tower panel and feeds back into the mass flow controller to restart the cycle. As 100% recycling is established progressively, the flow from the hydrogen bottle supply is closed off and adjustments to the rotameters are made as necessary. The reaction is then continued as fresh methane is injected into the furnace and thiophene and ferrocene are introduced (typically ferrocene last).

FIG. 2 shows a schematic piping and instrumentation diagram (P&ID) of a further embodiment of the temperature-controlled flow-through reactor of the invention. Individual mass flow controllers and the gas supplies are shown. This embodiment features an additional small rotameter (R) on a branch from the recycling line which is used to restrict the exhaust gas exiting for purification, analysis or pressure relief. In practice, the rotameter (R) sets the recycling ratio. In theory, this flow is equal to the fresh flow of methane into the furnace plus the gas liberated by the reaction minus the methane consumed.

### Summary of Experiments

Single-pass CNT sock formation was demonstrated with the collection box setup.
After engaging a 100% gas recycling loop, sock formation was demonstrated with only fresh methane being added at 30 ml/min (normally 100 ml/min or greater) into a 1.08 L/min re-metered gas stream along with reduced quantities of flushed-through thiophene (20 ml/min down from 60 ml/min) and typical quantities of flushed-through ferrocene (100 ml/min). Collection continued for 51 minutes with high continuity/minimal manual interference until it became clear the winder was becoming full. After first sample collection, the run was repeated with reduced methane (20 ml/min) and collection proceeded for 60 minutes until the winder was full.
Additional experiments were carried out to test gas purification alongside gas recycling, recycling rates below 100%, higher total flow rates and single-pass conditions for maximal throughput and continuity (minimise manual interference to collect sock).

### Practical Findings from Experimentation

The recycling loop should be engaged first by starting with a furnace tube running hydrogen only. Starting from conditions for a single-pass reaction will result in excess soot formation, potential clogging and less time to safely balance the flow rates for fresh input vs recycling pump vs water trap exhaust (which may experience back-suction if the pump is allowed to draw too much).
To develop a strong aerogel sock that will self-extrude and catch on the winding roller, higher initial delivery rates of methane should be used (eg double normal rate for 5 minutes) and ferrocene should be delivered last to introduce nanoparticles into a reagent rich environment. Reagent build-up in the recycled gas stream (carbon species and H₂S) to the point of aerogel formation otherwise takes longer (10 minutes for initial weak sock formation, 30 minutes or longer for proper stabilisation) due to the low fresh gas input rate (˜30 ml/min) relative to the equipment volume (˜14 L). Higher methane flows cannot be allowed to continue for too long however as soot formation will occur.
Continuous winding from a start of a run is highly beneficial in order to keep the end of the furnace tube clear of soot and CNT sock fragments. Soot build-up can encourage further material to catch preventing continuous winding. Extra heating elements around the end of the furnace tube may be deployed to keep the tube hot enough to prevent sticking right up until the collection box.
Gas mixtures may be used in place of pure methane. Mixtures tested include (resynthesized) industrial waste methane with high levels of H₂S, biogas-derived methane with high levels of CO and CO₂ (˜50%) and biogas-derived methane diluted with hydrogen (˜50% hydrogen, ˜30% CO). These mixtures have been successfully used to produce CNT films in a single-pass setup, usually with straightforward adjustments to the quantity of methane dispensed to compensate for the mixture.
It is conceivable that with some gas mixtures it may be difficult to spin and this can be remedied by diluting the gas mixture with pure methane. It is possible that additional complications may arise with dilute (pure) methane substitutions due to the build-up of unreactive species in the gas loop. In this case enrichment of dilute supply gases with purer methane may be necessary or fresh hydrogen may need to be continuously added to dilute contaminants. Additional purification techniques may be employed to remove contaminants.

1. A process for the production of a carbon nanotube product comprising:
(a) introducing sequentially or concurrently a metal catalyst precursor, a source of carbon and a sulphur-containing additive into a continuous flow of a hydrogen-containing carrier gas in a temperature-controlled flow-through reactor;
(b) exposing the metal catalyst precursor in the flow of the hydrogen-containing carrier gas to a first temperature zone sufficient to generate particulate metal catalyst;
(c) exposing the particulate metal catalyst, the source of carbon and the sulphur-containing additive to a second temperature zone downstream from the first temperature zone, wherein the second temperature zone is sufficient to produce a carbon nanotube aggregate;
(d) discharging the carbon nanotube aggregate as a continuous discharge through a discharge outlet of the temperature-controlled flow-through reactor;
(e) collecting the continuous discharge in the form of a carbon nanotube product; and
(f) recycling continuously an exhaust stream of hydrogen by-product exhausted from the discharge outlet into step (a) to progressively replace the continuous flow of the hydrogen-containing carrier gas.

2. A process as claimed in claim 1 wherein the source of carbon consists of methane.

3. A process as claimed in claim 1 wherein the source of carbon is bio-produced methane, natural gas, industrial waste methane or biogas-derived methane optionally diluted with hydrogen.

4. A temperature-controlled flow-through reactor for the production of a carbon nanotube product comprising:
an elongate refractory housing extending from an upstream end to a downstream end;
a feed system for releasing sequentially or concurrently a metal catalyst precursor, a source of carbon and a sulphur-containing additive into a continuous flow of a hydrogen-containing carrier gas;
an inlet at or near to the upstream end of the elongate refractory housing for introducing the continuous flow of the hydrogen-containing carrier gas which flows from the upstream end to the downstream end;
a thermal enclosure surrounding the elongate refractory housing which is adapted to provide an axial temperature variation between temperature zones in the elongate refractory housing, wherein the temperature zones include a first temperature zone sufficient to generate particulate metal catalyst and a second temperature zone sufficient to produce a carbon nanotube aggregate;
a collector for collecting from the downstream end a continuous discharge of the carbon nanotube aggregate in the form of a carbon nanotube product; and
a recycling system of pipework for continuously feeding into the feed system an exhaust stream of hydrogen by-product exhausted from the downstream end which progressively replaces the continuous flow of the hydrogen-containing carrier gas.

5. A temperature-controlled flow-through reactor as claimed in claim 4 wherein the recycling system of pipework comprises a primary pipeline between the downstream end and the feed system which incorporates a recycling pump.

6. A temperature-controlled flow-through reactor as claimed in claim 5 wherein the primary pipeline incorporates a flowmeter upstream from the recycling pump.

7. A temperature-controlled flow-through reactor as claimed in claim 5 wherein the primary pipeline incorporates a filter.

8. A temperature-controlled flow-through reactor as claimed in claim 4, wherein the recycling system of pipework comprises a secondary pipeline branched from the primary pipeline, wherein the secondary pipeline incorporates ancillary equipment.

9. A temperature-controlled flow-through reactor as claimed in claim 8 wherein the secondary pipeline incorporates a flowmeter which proportions the flow of the exhaust stream of hydrogen by-product between the ancillary equipment and the feed system.

10. A temperature-controlled flow-through reactor as claimed in claim 4, wherein the feed system comprises a controller for controlling the release of the metal catalyst precursor, the source of carbon and the sulphur-containing additive into the continuous flow of the hydrogen-containing carrier gas.

11. A temperature-controlled flow-through reactor as claimed in claim 10 wherein the controller further controls the feeding of the exhaust stream of hydrogen by-product into the feed system to progressively replace the continuous flow of the hydrogen-containing carrier gas.
